(19) United States
(12) Patent Application Publication
(10) Pub. No.: US 2026/0187174 A1
(43) Pub. Date: Jul. 2, 2026

(54) DATA EXTRACTION USING LLMS

(71) Applicant: Google LLC, Mountain View, CA (US)

(72) Inventors: Aarthi Ramachandran, Coimbatore (IN); Nidhi Gupta, Karnataka (IN)

(21) Appl. No.: 18/859,307

(22) PCT Filed: Sep. 20, 2023
(86) PCT No.: PCT/US2023/033204

§ 371 Date: Oct. 23, 2024

(51) Int. Cl. G06F 16/954; H04L 9/40

(52) U.S. Cl. CPC G06F 16/954; H04L 63/10

(57) ABSTRACT

Methods, systems, and apparatus, including computer programs encoded on a computer storage medium, for receiving information identifying a domain to be analyzed and identifying an entity referenced by the domain. The domain is queried, and a plurality of web pages located within the domain are received. The plurality of web pages is inputted into an artificial intelligence system that includes a large language model which extracts first content from a first web page among the plurality of web pages. The artificial intelligence system extracts second content from a second web page, the second content in a second format that differs from the first content. The artificial intelligence system generates third content representing a characterization of the entity based on the extracted first and second content. The generated characterization is an interpretation of the extracted first and second content.

### BACKGROUND

This specification relates to data processing and generative artificial intelligence with large language models.

### SUMMARY

In general, one innovative aspect of the subject matter described in this specification can be embodied in methods, computer readable mediums, and systems with instructions that include the actions of receiving information identifying a domain to be analyzed and identifying an entity referenced by the domain. The domain is queried and a plurality of web pages located within the domain are received. The plurality of web pages is inputted into an artificial intelligence system that includes a large language model which extracts first content from a first web page among the plurality of web pages. The first content being in a first format. The artificial intelligence system extracts second content from a second web page, the second content in a second format that differs from the first format. The artificial intelligence system generates third content representing a characterization of the entity based on the extracted first content and the extracted second content. The generated characterization is an interpretation of the extracted first and second content rather than a verbatim duplication of the extracted content. The generated characterization is outputted to a display device for a data processing apparatus.

These and other embodiments can each optionally include one or more of the following features.

In some instances, extracting, by the artificial intelligence system, second content from a second web page among the plurality of web pages includes extracting content that has not been structured for parsing by the artificial intelligence system.

In some instances, extracting, by the artificial intelligence system, first content from a first web page among the plurality of web pages includes extracting content from the first web page that has not been structured for parsing by a content extractor.

In some instances, the characterization is presented to the entity, and modification to the characterization are received from the entity. An augmented characterization is stored based on the modifications to the characterization.

In some instances, generating the characterization includes generating a hierarchical graph structure that includes at least one parent node representing a first attribute of the characterization and at least one leaf node representing a second attribute of the characterization.

In some instances, a digital component is generated for the entity based on the characterization. The digital component is distributed to a third party client device in conjunction with presentation of multiple different web pages provided by one or more different content providers, wherein each of the multiple different web pages is configured to have a the digital component inserted at the third party client devices rendering the multiple different web pages. In some instances, one or more distribution constrains that restrict distribution to the third party client devices having characteristics that meet the one or more distribution constraints are generated. Distributing the digital component to third party client devices in conjunction with presentation of multiple different web pages can include distributing the digital component to a first set of third party client devices having the characteristics that meet the one or more distribution constraints, and preventing distribution of the digital component to a second set of the third party client devices lacking one or more of the characteristics that meet the one or more distribution constraints.

Particular embodiments of the subject matter described in this specification can be implemented so as to realize one or more of the following advantages. Advantages of the techniques discussed herein include overcoming the limitations of existing tools that assist entities in creating digital components. For example, content extractors that exist today are limited to parsing content that has been specifically structured for parsing by the content extractors, e.g., according to a specific structure that the content extractors can recognize and parse, such that existing content extractors are not effective for parsing/extracting content from online resources that have not been properly structured for parsing. Alternatively, existing content extractors might be modular, requiring one module per identified format, and adding additional processing to execute such known tools. Furthermore, existing content extractors are generally only capable of extracting verbatim information from online resources, such that there is only one way the extracted information is extracted/provided. In contrast, the techniques discussed herein are capable of parsing/extracting information irrespective of its format, e.g., without the need for the content to be structured in any specific way, and also capable of using the extracted information to generate new content that interprets the parsed/extracted information in a variety of ways, rather than simply outputting verbatim snippets of extracted text. For example, depending on the intended purpose of the new content, the techniques discussed herein are capable of customizing the new content for the intended purpose, including generating different sets of new text, in different formats, such that each different set of new text is more suited for use in the intended purpose. For example, each new different set of text can be less likely to be rejected for lack of compliance with standard quality checks because of the ability to interpret the extracted text rather than simply outputting verbatim text. The advantages described above can be achieved, for example, by inputting a set of content (e.g., content of multiple different web pages) into an artificial intelligence system that is configured to recognize/extract relevant portions of the content, irrespective of its structure/format, and generate a characterization of an entity based on the interpretation of the extracted content, where the characterization includes an interpretation of the input content, rather than simply outputting a verbatim reproduction of the extracted content. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which generative artificial intelligence can be implemented.

FIG. 2 is a block diagram illustrating interactions between an artificial intelligence system, a text generative model, an entity analysis model, and a client device.

FIG. 3 is a flow chart of an example process for performing entity analysis with artificial intelligence.

FIG. 4 is an example graph output of an entity analysis for a service-based company.

FIG. 5 is an example graph output of an entity analysis for a products-based company.

FIG. 6 a block diagram of an example computer.

Like reference numbers and designations in the various drawings indicate like elements.

### DETAILED DESCRIPTION

This specification describes techniques for enabling artificial intelligence to extract content from a website or domain and other public sources to synthesize an understanding of a particular entity. Artificial intelligence (AI) is a segment of computer science that focuses on the creation of models that can perform tasks act autonomously (e.g., with little to no human intervention). Artificial intelligence systems can utilize, for example, one or more of machine learning, natural language processing, or computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

The techniques described throughout this specification enable artificial intelligence to generate and enhance a deep, holistic characterization of a particular entity. This characterization can be readily implemented in future services as well as providing more efficient data/content creation, which can help guide users through an information gathering and end action cycle, such as educating themselves about a particular item, and then acquiring that item based on the data/content created using the characterization. An entity can be, for example, a person, company, business, group of businesses, place, object, or concept. For example, an entity can be a brand associated with a group of products sold by a particular business. Traditional techniques require users to provide item details in a particular structured format to obtain specialized/personalized information about the item they are investigating. The disclosed techniques enable a provider of the item (or an information source regarding the item) to automatically extract key details about the item that are relevant to the user without manual input from the user, and then generate appropriate content among other things.

For example, one or more artificial intelligence systems (referred to simply as “artificial intelligence system” or “AI system” for brevity) can be configured to create a characterization of an entity using a set of content, such as a set of web pages. More specifically, the artificial intelligence system can perform an analysis of each web page among the set of web pages (e.g., such as web pages within a same second level domain) and extract relevant information such as presence (e.g., online or in-person), age, principles, items referenced, services referenced, reputation or social media sentiment, etc.

The artificial intelligence system can perform this extraction, as well as other functionality described herein, without requiring the content of the web page to include specific markup language, or otherwise be structured in a particular way to facilitate parsing. In this way, the AI system can extract information from a web page that is considered unparsable in the context of traditional content extractors, which require content to include specific markup language, or otherwise be structured in a specific way to enable parsing of the content.

The one or more artificial intelligence systems can also be trained to recognize particular aspects, attributes, qualities, and/or identifying features within the set of web pages, which can be used to provide context, and generate the characterization output by the artificial intelligence system. In some implementations, the artificial intelligence system uses additional resources, such as third-party data to augment the content that is available in the set of web pages. For example, the artificial intelligence systems may use online maps data, job listing data, business information, or other suitable third-party data as additional or augmenting input to provide context for generating the characterization that is output by the artificial intelligence system.

Altogether the artificial intelligence system can develop an interpretation of an entity referenced by the set of web pages as a whole. For example, in the context of an online entity, such as an e-commerce entity or a manufacturer, the AI system can interpret the content from the set of web pages to create a characterization of the online entity, including for example, their business model, brand intent, products and services offered, temporal events or promotions offered, and relationships between different elements of the online entity. These relationships can include relationships between the online entity and other online entities. In some implementations, the extracted information and/or generated characterization is structured as a hierarchical graph that has one or more parent/daughter nodes with one or more leaf nodes that generally captures relationships between the different elements of the entity or company.

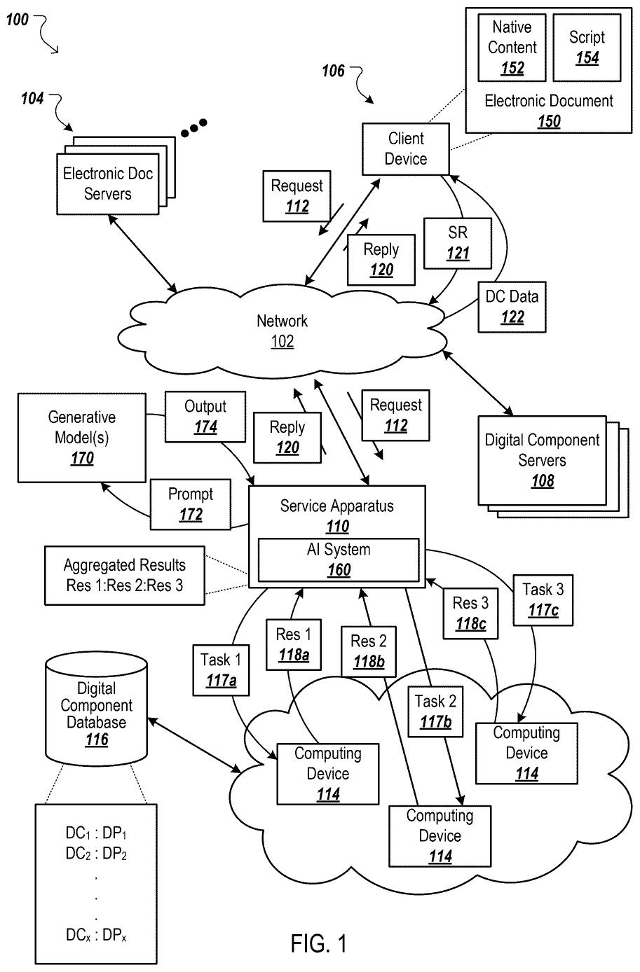

FIG. 1 is a block diagram of an example environment 100 in which generative artificial intelligence can be implemented. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160. Although the artificial intelligence system 160 is depicted by a separate box and described separately in this document, the entire service apparatus 110 can be considered an artificial intelligence system. The artificial intelligence system 160 is configured to autonomously review electronic documents 150 and other data to extract entity content associated with a target company, for example, in digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and create or cause the creation of one or more objects, or scores representing the entity's brand and/or business.

The environment 100 also includes a generative model 170. Although only one generative model 170 is depicted in FIG. 1, the generative model 170 can represent a set of multiple generative models that can each be specially configured to perform certain tasks. For example, as described in more detail below, the set of generative models represented by generative model 170 can include a large language model (“LLM”) that is configured to summarize textual content about a given object that is located at one or more online locations (e.g., web pages or other online resources).

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code. For brevity, large language models are also referred to herein as “language models.”

The language model can be any appropriate language model neural network that receives an input sequence made up of text tokens selected from a vocabulary and auto-regressively generates an output sequence made up of text tokens from the vocabulary. For example, the language model can be a Transformer-based language model neural network or a recurrent neural network-based language model.

In some situations, the language model can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model can process the current input sequence to generate a score distribution (e.g., a probability distribution) that assigns a respective score, e.g., a respective probability, to each token in the vocabulary of tokens. The neural network of the language model 170 can then select, as the particular token, a token from the vocabulary using the score distribution. For example, the neural network of the language model can greedily select the highest-scoring token or can sample, e.g., using nucleus sampling or another sampling technique, a token from the distribution.

As a particular example, the language model can be an auto-regressive Transformer-based neural network that includes (i) a plurality of attention blocks that each apply a self-attention operation and (ii) an output subnetwork that processes an output of the last attention block to generate the score distribution.

The language model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CORR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model to generate multiple different candidate output sequences in response to the same request, e.g., by using beam search decoding from score distributions generated by the language model, using a Sample-and-Rank decoding strategy, by using different random seeds for the pseudo-random number generator that's used in sampling for different runs through the language model or using another decoding strategy that leverages the auto-regressive nature of the language model.

In some implementations, the language model is pre-trained, i.e., trained on a language modeling task that does not require providing evidence in response to user questions, and the service apparatus 110 (e.g., using AI system 160) causes the language model to generate output sequences according to the predetermined syntax through natural language prompts in the input sequence.

For example, the service apparatus 110 (e.g., AI system 160), or a separate training system, pre-trains the language model (e.g., the neural network) on a language modeling task, e.g., a task that requires predicting, given a current sequence of text tokens, the next token that follows the current sequence in the training data. As a particular example, the language model can be pre-trained on a maximum-likelihood objective on a large dataset of text, e.g., text that is publicly available from the Internet or another text corpus.

In some implementations, the AI system 160 can generate a prompt 172 (e.g., an initial prompt) that is submitted to the language model (e.g., one of the generative models 170), and causes the language model to generate output sequences 174, also referred to as passages or simply as “output”. The AI system 160 can generate the prompt in a manner (e.g., having a structure) that identifies a list of one or more online sources of information, such as a list of one or more websites or data repositories, and specifying a set of constraints the language model must use to generate the output 174 using the prompt 172. In some implementations, prompt 172 is one or more HTML web pages, or a consolidation of extracted data from one or more web pages.

To initiate creation of the output sequences 174, the AI system 160 submits the prompt 172 to the one or more generative models 170, which use the prompt 172 to evaluate textual information, markup information, or image information found at the one or more online sources specified in the prompt 172 and generate the output 174 that represents a generated characterization object associated with a target company or entity. In some implementations, output 174 is a recommendation or a generated digital content. In some implementations, output 174 is a score representing how applicable particular digital content is to a target entity. In some implementations, output 174 is a recommended request or set of requests associated with particular digital content based on the time or location of that digital content. Output 174 can be defined or limited according to the constraints specified in the prompt 172. For example, assume that the AI system 160 uses the following template to create the prompt 172 (e.g., “initial prompt”):
Perform an entity analysis for a digital component for: ‘{Text}’ by ‘{Visurl}’. There should be no people or text in the photo. Answer with just the prompt as a python string.

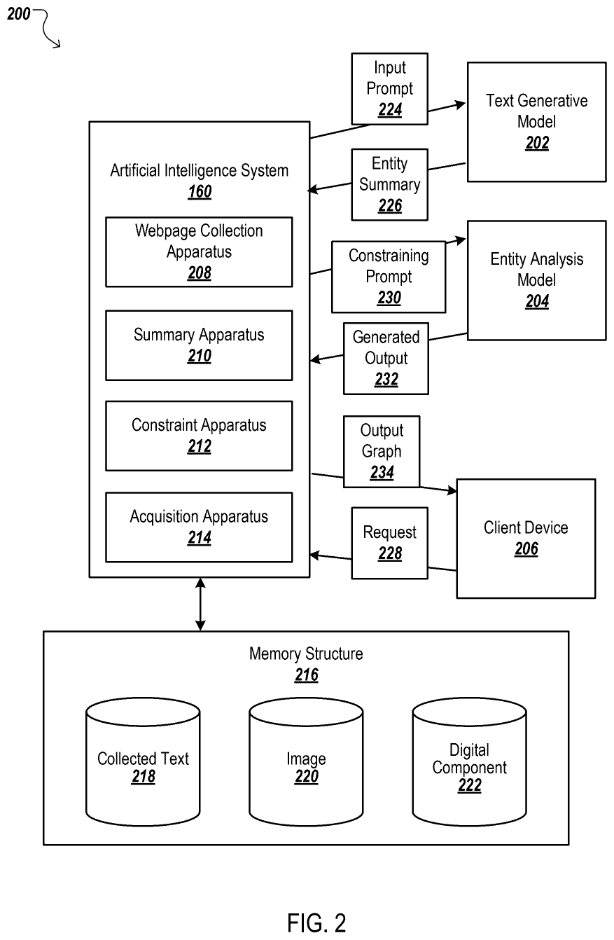

In this example, the “Text” can be a placeholder for a set of text that is included in the digital component for which the constrained prompt is to be generated, and “Visurl” can be a URL linked to by the digital component, such as a web page address of a given web page. As discussed in more detail with reference to FIG. 2, the AI system 160 can populate this prompt template with the appropriate text and URL, and submit the populated prompt to the generative model 170 (e.g., an LLM in the set of LLMs represented by generative model 170), which causes the generative model 170 to process the prompt 172 and return the output 174, which can take the form of a graph or company summary that provides a description of an object described by text located at the URL.

The AI system 160 can use the generated summary as part of an additional prompt 172 (e.g., a constraining prompt) that is sent to the generative model 170. For example, the AI system 160 can insert the generated summary or graph into the additional prompt 172 that is generated after receiving the output 174 (e.g., initial output) generated using the initial prompt (e.g., the prompt generated after receiving the image summary), and submit the additional prompt 172 (e.g., constraining prompt) to the generative model 170 (e.g., a text-to-image generative model) as a constraint for generating images for use in digital components generated and/or distributed by the AI system 160.

Submission of this additional prompt 172 to the generative model 170 causes the generative model 170 to generate an additional output 174, which is communicated electronically to the AI system 160. The AI system 160 receives the additional output 174, and can use the additional output 174 to generate or augment one or more digital components that are available to be provided in response to the request 112. In some implementations, each different digital component can include a different combination of text and/or images generated by the generative model 170. For example, assume that the additional output 174 includes twelve different images, and that the formatting of the digital components being generated or distributed by the AI system 160 each include space for a single image. In this example, the AI system 160 could create twelve different digital components that each include the same set of text but include a different one of the 12 different images.

Additionally, the domain or set of websites, company, or entity for inclusion with a given set of text for any individual request 112, could be determined by the services apparatus 110/AI system 160 based on the context of the request (e.g., geographical origins of the request 112, time of day, keywords, etc.). In this way, the combination of and company, entity characterization, website domain and text provided in response to each request 112 can be determined at the time of the request.

The additional output 174 generated using the additional prompt 172 can be provided to a content provider (e.g., digital component provider) for approval prior to being included in a digital component. In some implementations, the output 174 can be surfaced to the content provider as part of an account chat interface. For example, the content provider's account user interface can include a conversational assistant feature that enables the content provider to request information by way of a natural language system. In this example, creation/presentation of outputs generated by the generative model 170 can be triggered, for example, by the content provider submitting a request for suggestions of images that the content provider could include in digital components being distributed by the service apparatus 110.

In response to receiving the request from the content provider, the service apparatus 110 (e.g., by way of the AI system 160) can generate the initial prompt and additional prompts as discussed above and submit the constraining prompt to the generative model 170 to obtain extracted data and graphs by the generative model 170. The service apparatus 110 can render the graph representing company and an entity characterization and present it as a set of the images (e.g., one or more of the images) to the content provider through the account user interface (e.g., in the chat interface or a separate pane). The images can be presented by themselves, or the service apparatus 110 can combine the images with text of the digital components being distributed on behalf of the content provider to provide the content provider with a preview of how the digital components will appear when distributed with one or more of the images. In either case, the content provider can either authorize one or more of the graphs for distribution in the digital components or decline the option to have the one or more graphs presented in the digital components.

Instead of, or in addition to, generating/presenting the graphs based on interactions by the content provider with an interactive chat interface, the service apparatus 110 can generate the outputs in an “offline” process, and present the outputs, e.g., as recommendations, when the content provider accesses their account. In some implementations, the service apparatus 110 can make the decision to generate the outputs, as described above and in more detail below with reference to FIG. 2, based on one or more factors related to the account of the content provider. For example, the service apparatus 110 may trigger the creation of the prompts (e.g., initial and constraining prompts) in response to determining that the digital components distributed on behalf of the content provider do not include or present images, or that fewer than a specified portion (e.g., percentage) of the digital components include/present images.

Once the above determination is made, the generated prompts can be used, as described throughout this document, to create outputs that are recommended for incorporation into the digital components distributed on behalf of the content provider. In some implementations, the recommendations (or at least the availability of the recommendations) can be presented at a welcome page of the content provider's account. In some implementations, the recommendations can be presented in a recommendations tab or page of the content provider's account for review by the content provider. Each of the recommendations (e.g., recommended graphs) can be presented with (e.g., adjacent to) an interactive user interface control that enables the content provider to authorize use of the image generated by the generative model 170, or dismiss the recommendation to use the image in digital components. In response to a given recommended image being authorized (e.g., through user interaction with the user interface control), the service apparatus 110 can store the authorized output as an image that is available for output (e.g., serving) with/in a digital component distributed on behalf of the content provider in response to a request 112 from a client device 106.

The AI system 160 can perform one or more post-processing operations that evaluate one or more characteristics of the output generated by the generative model 170. The post-processing operations can be performed on the graphs themselves, as received in the output 174 from the generative model 170. The post-processing operations can also be performed on a combination of the text and images that, together, constitute an updated/augmented digital component. For example, when the post-processing operations are performed on the combination of the text of the digital component and one or more images generated by the generative model 170, the evaluation of the generated images can be performed in the context of the text with which the images would appear. Of course, even in these situations, the images could still be evaluated in isolation of (e.g., independent of) the text of the digital component, which would reveal to the service apparatus 110 whether the image itself may still be a good candidate for inclusion with other text, or whether the image itself should be discarded from consideration.

In some implementations, the post-processing operations can include generating a plausibility score for each output generated by the generative model 170. The plausibility score is a value specifying a likelihood that the generated output of an object is consistent with accurate/real representations of the object. The generation of the plausibility score is discussed in more detail with reference to FIG. 2.

The post-processing operations can also include an evaluation of the relevance of the outputs to the input prompt, textual content of a digital component, or textual content about the object presented at a specified network location. The post-processing operations can also include an evaluation of similarity between the generated output (e.g., created using the generative model 170) to outputs of the object provided by the content provider. The post-processing operations can also include a determination as to whether the output generated by the generative model 170 violates one or more content policies, such as violating copyright rules, violating family safe content policies, or whether insertion of the image in a digital component will overlap/occlude text of the digital component, an entity logo that is part of the digital component, or a link to an online resource (or triggers an action) that is embedded in the digital component. As discussed in more detail with reference to FIG. 2, the post-processing operations can be used to score, or otherwise assign a level of priority to, each of the outputs so that the AI system 160 can rank the multiple outputs relative to each other, and ultimately serve one or more of the highest ranking outputs for presentation to the content provider or in a digital component provided in response to a request 112 from a client device 106. Note that one or more operations of the AI system 160 and generative model 170 can be performed responsive to receipt of the request 112 or can be performed prior to receipt of the request 112.

FIG. 2 is a block diagram 200 illustrating interactions between an artificial intelligence system 160, a text generative model (“text model”) 202, an entity analysis generative model 204, and a client device 206. In some situations, the text model 202 and the entity analysis 204 can both be part of the language model 170 discussed above with reference to FIG. 1. Similarly, the client device 206 can be the same or similar to the client device 106 of FIG. 1. The artificial intelligence system 160 can be part of the service apparatus 110 of FIG. 1, such that the description of the artificial intelligence system 160 can also be considered a description of the service apparatus 110.

The entity analysis model 204 is configured to accept, as input, constraining prompts 230, as well as entity summary 226, and generate, as output, recommendations or evaluations associated with an entity in the form of generated output 232. Generated output 232 can be, for example, a score of certain particular digital content evaluating how well it fits within the entity analyzed in the entity summary 226. In another example, generated output 232 can be a recommendation for modifications to digital content to cause it to better conform with entity summary 226. In some implementations, the generated output 232 can be converted to a graph or image and provided to the client device 206 as an output graph 234. In some implementations generated output 232 is a request, recommended request amount, or recommended request time in order to maximize digital content revenue or constraint. Although a single entity analysis model 204 is depicted in FIG. 2, the entity analysis model 204 can be a collection of multiple models that can each be specially trained to generate different outputs such as images, recommendations, scores, or others.

The text model 202 is configured to accept, as input, a text (or voice) prompt or HTML and generate a textual response, which can be output as a entity summary 226, which can be a hierarchical structure or a text structure that can be readily transformed into a hierarchical structure. Although a single text model 202 is depicted in FIG. 2, the text model 202 can include a set of different text models that are invoked to perform different tasks for which the different text models are specially trained. For example, one text model within the set of text models may be specially trained to perform content summary tasks, while another text model may be specially trained to generate a prompt for the entity analysis model 204, for example, using the summary output of the specially trained summary text model. Furthermore, the set of models can include a generalized text model that is larger is size, and capable of generating large amounts of diverse datasets, but this generalized text model may have higher latency than the specialized text models, which can make it less desirable for use in real-time operations, depending on time latency constraints required to generate content. Each text model can be implemented by way of an LLM, or another model that is configured to generate natural language text responsive to a prompt.

The artificial intelligence system 160 includes a webpage collection apparatus 208, a summary apparatus 210, a constraint apparatus 212, and a request apparatus 214. The following description refers to these different apparatuses as being implemented independently and each configured to perform a set of operations, but any of these apparatuses could be combined to perform the operations discussed below.

The artificial intelligence system 160 is in communication with a memory structure 216. The memory structure 216, can include one or more databases. As shown, the memory structure includes a collected text database 218, an image database 220, and a digital component database 222. Each of these databases 218, 220, and 222, can be implemented in a same hardware memory device, separate hardware memory devices, and/or implemented in a distributed cloud computing environment (or another data storage apparatus).

The webpage apparatus 208 is implemented using at least one computing device (e.g., one or more processors), and can include one or more language models. The webpage collection apparatus 208 is configured (e.g., specially programmed with executable code and/or implemented with specialized hardware) to collect information provided by online data sources, such as web pages. In some implementations, the collected information includes text collected from one or more specified online resources.

To obtain the text or HTML, the webpage collection apparatus 208 can crawl a specified online resource or domain, such as a landing page or plurality of web pages to which an existing digital component is linked or another source of information about an object described by the existing digital component. For example, assume that a digital component is stored in the digital component database 222, and links to example.com. In this example, the webpage collection apparatus 208 can identify the link to example.com in the stored digital component, and crawl example.com to obtain/discover text and images presented by example.com. The obtained text can be stored in the collected text database 218 and obtained from the collected text database 218 when an operation that uses text as input is triggered (e.g., launched or executed). In some implementations text database 218 further includes HTML extracted or downloaded from example.com and several of its web pages.

The crawling of the specified resource can be performed in an offline process (e.g., prior to when the obtained text is to be used by the AI system 160). For example, the resource crawling can be performed as part of a routine crawling performed by the AI system 160 at scheduled intervals. In some implementations, the crawling is performed in an online process (e.g., in response to a request for the AI system 160 to perform an operation that uses the text as input). For example, assume that the AI system 160 initiates an operation to generate images for a digital component that includes a link to example.com. In this example, the AI system 160 can access the collected text database 218, and search for text obtained from example.com that is stored in the collected text database 218. When the search of the collected text database 218 returns text obtained from example.com, the returned text can be used to perform the image generation. However, when the AI system 160 determines that the search of the collected text database does not return text obtained from example.com, the AI system 160 can trigger a crawl of example.com to obtain text (e.g., using the webpage collection apparatus 208). In this situation, the AI system 160 can use the text obtained by crawling example.com to generate images, and store the text obtained in the collected webpage database 218 for future use.

Additionally, or alternatively, the webpage collection apparatus 208 can be configured to collect text, HTML, or image information from an account storing distribution parameters that contribute to the distribution of the digital component. For example, the webpage collection apparatus 208 can identify keywords, object/service descriptions, headlines, or other text contained in the account, and use this identified text as an input to the image generation processes discussed throughout this specification.

Additionally, or alternatively, the webpage collection apparatus 208 can be configured to issue/submit a query to a search system that responds to the query with information about a topic and/or an entity discussed in the stored digital component (or another topic/entity). In some implementations, the webpage collection apparatus 208 can parse, or otherwise process, the search result snippets that are returned by the search system in response to submission of the query by the webpage collection apparatus 208 to obtain text related to the topic/entity. The collected text can be stored, for example, in the collected text database 218.

When an entity (e.g., a company) has an online presence, e.g., website, that provides information about the entity, the query submitted by the webpage collection apparatus 208 can be a site-constrained query that causes the search system to only reply to the site-constrained query with information contained a specified site or domain (e.g., the website of the company). Of course, multiple site constrained queries can be issued for multiple different sites, or multiple different sites can be specified in the site-constrained query that causes the search system to collect information related to the query from multiple different specified sites (e.g., a social networking site, web answers site, entity review site, etc.). The site constraint can be specified, for example, as a second level domain, or a specific page address depending on where the information is to be sourced from.

The webpage collection apparatus 208 can collect other text or HTML from other sources. In some implementations, the webpage collection apparatus 208 can be configured to collect conversational input submitted to the AI system 160 and use this conversational input in the entity analysis processes discussed herein.

The webpage collection apparatus 208 can store any, or all, of the collected text in the collected text database 218 in a manner that facilitates retrieval of the text at a later time. For example, the webpage collection apparatus 208 can index the collected text to the digital component, digital component provider, website, or another reference that will facilitate retrieval of the text when the AI system 160 is performing operations related to generating an image for the digital component provider.

The summary apparatus 210 is implemented using at least one computing device (e.g., a device including one or more processors), and can include one or more language models. The summary apparatus 210 is configured to summarize information about a topic or entity (e.g., person, place, thing, or concept). In some implementations, the summary apparatus 210 is configured to summarize the text collected by the webpage collection apparatus 208, and potentially stored in the collected text database 218. For example, the summary apparatus 210 can be configured to accept, as input, the collected text, and output a specified length (e.g., 200 words or some other number of words) summary of the contents of the collected text.

The summary can be generated using the text generative model 202, which can be part of the summary apparatus 210, or in data communication with the summary apparatus 210. In some implementations, the summary apparatus 210 (or the constraint apparatus 212 discussed below) can generate a summary prompt that is submitted to the text model 202 as an input prompt 224. In some implementations, the summary apparatus 210 uses a language model (e.g., text model 202) that has been specially trained to generate text summaries using content of web pages or other sources and the summary prompt. The summary prompt can specify one or more of the following:
a set of sources that should be used to generate the summary;
details about the set of sources the language model should consider when summarizing the content;
factual grounding instructions specifying that the language model should provide citations to the sources used to generate the summary;
summary constraints specifying information that should not be included in the summary (e.g., information that is not directly supported by the set of sources); and
formatting constraints specifying how the output of the language model should be formatted (e.g., as bullet points or in paragraph form, with or without an introduction summary, total length (e.g., number of characters or separate clauses); and
tone constraints specifying a tone of the output (e.g., creative, funny, sad, serious, or from the perspective of a specified entity, such as an artist, engineer, or story writer).

An example summary prompt can take the form of:
“Given a question and a list of sources, write a short summary that cites individual sources and summarizes all of them as comprehensively as possible. Each source is independent and might repeat or contradict content from other sources. The summary should be directly supported by the given sources and cited appropriately with a [$i] notation following a statement that is supported by $i. If a statement is based on multiple sources, all of these sources should be listed in the brackets, for example [$i, $j, $k]. The summary may start with a general statement about the answer space. The summary shouldn't include any information that cannot be supported by the given sources.”

In this example, the notation $i can placeholders for the names of the sources. The bolded “a list of sources” can be replaced with the names of actual sources to be considered, or be a reference to locations of sources in the set of sources to be considered when creating the summary. The set of sources can be network addresses (e.g., universal resource indicators/locators-URIs/URLs) of online data sources (e.g., second level domains of websites, specific addresses of web pages, or network addressees of other data sources). In some implementations, the set of sources can include the collected text database 218, such that the summary can be generated using the text already collected and stored by the webpage collection apparatus 208. The summary apparatus 210 uses the summary prompt to generate a text summary that summarizes text collected form one or more network locations of the set of sources into a passage summary. As noted above the text summary can be formatted as a set of bullet points or in paragraph form.

The text summary is generated by a text model 202, which as noted above, can be part of the summary apparatus 210, or in data communication with the summary apparatus 210. In either case, the summary apparatus 210 inputs the summary prompt into the text model 202 as an input prompt 224. The text model 202 (e.g., an LLM) processes the input prompt 224, and generates a natural language output (“NL Output”) 226 that summarizes the text (or other content) of the set of sources according to the instructions/constraints specified in the summary prompt.

An example paragraph summary of a set of sources that provide information about Example Search Co. can take the form of:
Example Search Co's brand identity is one of simplicity, clarity, and accessibility. The company's logo, a colorful, sans-serif E, is instantly recognizable and easy to remember. The color palette is also simple, with a focus on blue and green, which are associated with trust and reliability. Example Search Co's typography is also clear and easy to read, even at small sizes. The overall tone of Example Search Co's brand identity is friendly and approachable.

The company's marketing materials often feature simple, humorous illustrations that help to make Example Search Co's products and services more relatable to users. Example Search Co. also emphasizes its commitment to making information accessible to everyone, regardless of their background or technical expertise.

An example bullet point summary of the same set of sources can take the form of:

Here are some key aspects of Example Search Co's brand identity:
Trustworthiness: Example Search Co. is known for its reliable and trustworthy search engine. The company also has a strong commitment to privacy and security.
Innovation: Example Search Co. is constantly innovating and releasing new products and services. The company is known for its ability to anticipate user needs and deliver innovative solutions.
Accessibility: Example Search Co's products and services are designed to be accessible to everyone, regardless of their background or technical expertise.
Social responsibility: Example Search Co. is committed to using its technology to make a positive impact on the world. The company has a number of initiatives in place to promote sustainability, diversity, and inclusion.

The summary can be generated in response to receipt of a request 228 from a client device 206 (e.g., in a real-time or online mode), or generated in an offline mode (e.g., independent of receipt of an instance of the request 228 from a client device 206. The request 228 can be, for example, from a digital component provider, and be requesting an analysis of one or more entities associated with one or more companies. The request 228 can be generated and submitted to the AI system 160 based on a conversational input of the digital component provider to an AI chat interface at the client device 206.

In the real-time/online mode, the request 228 received from the client device can be passed to the summary apparatus 210 in parallel with other processing being performed in response to the request 228, such as generating a conversational response to the request 228, so that the summary apparatus 210 can generate the summary while other request 228 processing operations are being performed, thereby reducing the latency associated with providing the client device 206 with the final response to the request 228. For example, while the summary apparatus 210 is generating the text summary, the AI system 160 can be generating conversational response to the digital component provider, such as, “Do you have a preferred color or shape for the object that will be presented in the digital component?”, which can be transmitted back to the client device 206 and/or presented in the AI chat interface.

In the offline mode, the summary apparatus 210 can generate summaries for anticipated requests that can be stored in the memory structure 216 for use when the request 228 is received from the client device 206. For example, the summary apparatus 210 can identify a set of digital component providers who are most likely to submit the request 228 for generation of images to be included in, or distributed with, their digital components. In some implementations, the AI system 160 can identify a set of digital component providers based on characteristics of digital component providers who have previously submitted similar requests for images.

Continuing with the discussion of the summary apparatus 210, the summary apparatus 210 can, for each digital component provider among those digital component providers most likely to submit the request (referred to as prospective requestors), identify a set of sources relevant to the digital component provider and/or their stored digital components, and perform operations similar to those discussed above to generate a set of summaries (e.g., one or more summaries) for each of the prospective requestors. This set of summaries can be stored in the memory structure 216 (e.g., with an index to the corresponding digital component provider), and when the request 228 is received from the client device 206 of one of the prospective requestors, the summary apparatus 210 (or another apparatus in the AI system 160), can query the memory structure 214 to retrieve one or more of the summaries indexed to the digital component provider who submitted the request 228 to facilitate operations performed using the summaries, as discussed in more detail below. Generating summaries in the offline mode can reduce latency associated with responding to the request 228 submitted by the client device 206 because the operations required to generate the summaries will not preclude downstream operations that rely on the summary, as discussed below.

In some implementations, the summary is provided to a constraint apparatus 212, which is implemented using at least one computing device (e.g., a device including one or more processors), and can include one or more language models. The constraint apparatus 212 is configured to generate queries that are submitted to language models, such as the text model 202 and the entity analysis model 204. In some implementations, the constraint apparatus 212 creates an initial prompt that is submitted to a language model (e.g., the text model 202) to obtain an appropriate analysis of an entity or company, which is then submitted in prompt to another language model (e.g., the entity analysis model 204) to obtain improved entity summaries 226 or generated outputs 232 using the constraining prompt.

The initial prompt created by the targeting apparatus 212 generally includes one or more specified network locations and a set of constraints that limits clauses generated by a language model. The one or more specified network locations can be, for example, one or more of a network address (e.g., second level domain or web page address) that is included in a digital component (e.g., linked to by the digital component), or another network location (e.g., the collected text database 218) from which information related to the digital component can be obtained. The information related to the digital component can include text, as discussed above, or other information, such as images of objects related to the digital component. When the information includes images, the AI system 160 can use computer vision, for example, to analyze the images and/or generate a visual description of the images.

As noted above, the information obtained from the specified network location can be used to generate a summary of the content provided at the specified network location, which can also be included in the initial prompt. The summary can summarize textual content, a visual description of the images at the specified network location, or both.

The constraint apparatus 212 (or another component of the AI System 160) transmits, conveys, communicates, or otherwise submits the constructed initial prompt to the text model 202 as an input prompt 224. The text model 202 uses the initial prompt to generate a response, which is provided back to the AI system 160 in the form of the entity summary 226. The entity summary 226 can include a set of clauses formatted according to formatting constraints specified in the input prompt 224. For example, if the input prompt 224 includes a formatting constraint specifying that the response should be an analysis prompt in the form of a python string, the text model 202 can output a visual description similar to those shown above in the form of a python string.

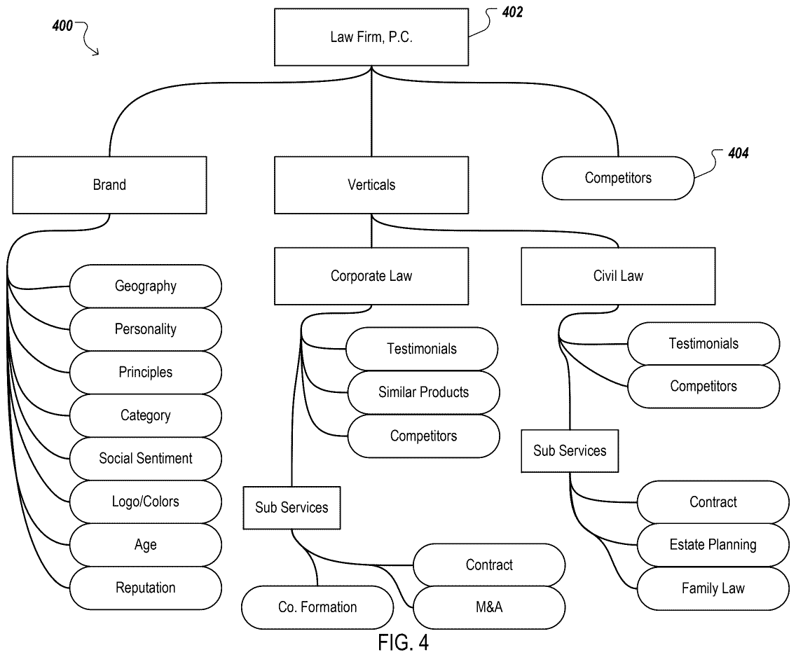

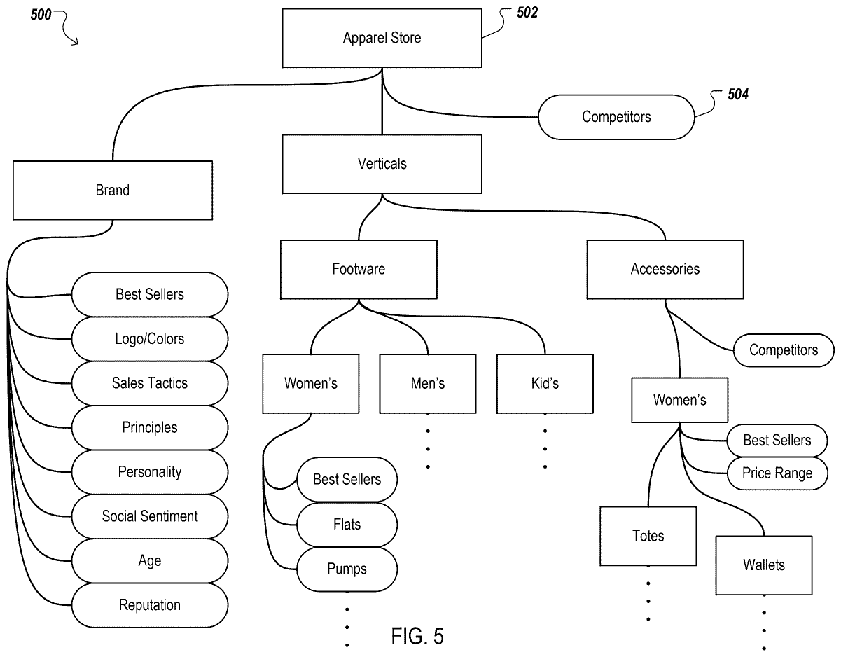

The constraint apparatus 212 receives the entity summary 226 that contains a summary generated by the text model 202. The entity summary 226 can generally aggregate a holistic knowledge of the summarized company or entity. In some implementations, the entity summary is a hierarchical graph structure containing one or more nodes and edges, the nodes and edges can each have a weight and can be arranged to represent the various interrelated components of the entity or company. Examples of entity summaries are provided below with respect to FIG. 4 and FIG. 5.

The constraint apparatus 212 generates a constraining prompt 230 that includes the entity summary, and one or more selected digital content elements provided from the client device 206. The one or more selected digital content elements can be identified in the request 228, or in follow up communications. In some implementations, the entity summary 226 of the text model 202 generated responsive to the initial prompt can be simply designated as the constraining prompt 230 without modification. In these implementations, causing the text model 202 to generate the entity summary 226 can be considered to constitute generating the constraining prompt 230. In some implementations, the constraint apparatus 212 modifies/supplements the entity summary 226 with additional information to generate the constraining prompt 230. For example, contextual constraints or additional formatting constraints can be added to the entity summary 226 to generate the constraining prompt 230. The contextual constraints can specify, for example, a geographical distribution area of a digital component with which the digital content will be presented, a time of day/month/year during which the digital content will be distributed with the digital component, characteristics of an audience to whom the digital content will be presented, or other contextual information. Including these contextual constraints in the constraining prompt 230 with the entity summary 226 can cause the entity analysis 204 to customize the visual characteristics of the digital content generated based on the context in which the digital content is being generated will be presented. In some implementations, instead of or in addition to customizing visual characteristics, the entity analysis model 204 can provide a score, ranking, or otherwise evaluate a selected or prospective digital content in light of the entity summary 226.

Similarly, an acquisition apparatus 214 can receive a request 228 which can include selected digital content, service or product. acquisition apparatus 214 can generate a constraining prompt 230 which causes entity analysis model 204 to analyze the entity summary 226 in light of a particular product or service, and provide a generated output 232 that is an acquisition recommendation. The acquisition recommendation can be, for example, a recommended price, time period, or location in which a request for digital content presentation will be most effective at enabling particular digital content to reach a target audience. In some implementations, acquisition apparatus 214 receives additional external data, such as real-time inventory/availability data, or real-time foot traffic data associated with a geographic region. This data can be stored in memory structure 216, e.g., as digital components 222 and can be updated or maintained by external systems. In some implementations, this additional data is provided with request 228 from client device 206.

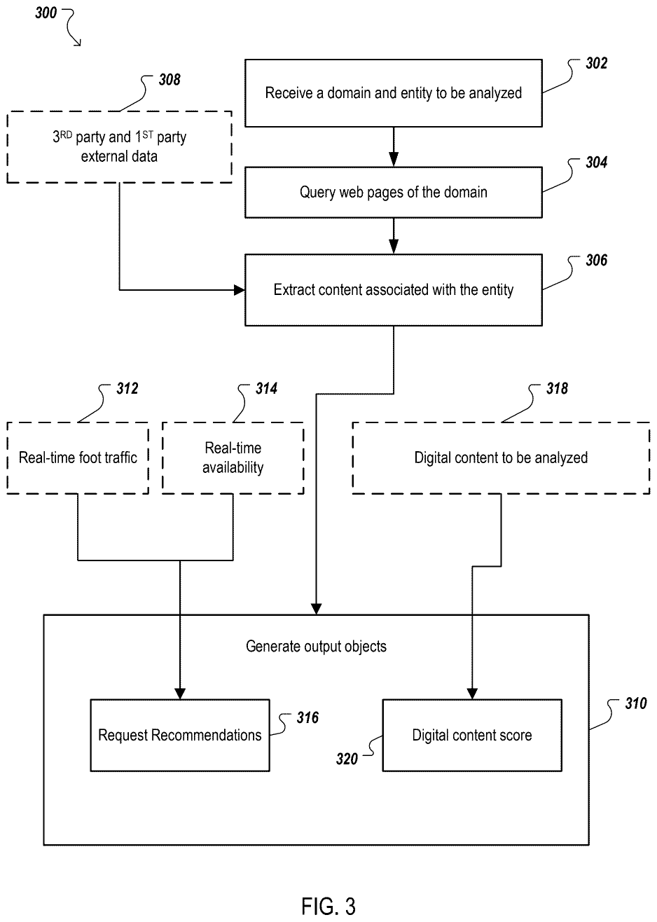

FIG. 3 is a flow chart of an example process 300 for performing entity analysis with artificial intelligence. Process 300 can be executed by an artificial intelligence system (e.g., service apparatus 110 of FIG. 1) or a portion thereof.

At 303, an entity and associated domain to be analyzed is received. This can be, for example, the entity “Example Candy Co.”, with the domain “example.com/candyco” as a base domain to be analyzed for the entity. In some implementations, multiple entities can be received (e.g., “chocolate candies” and “fruit candies”) for the same domain. In some implementations, multiple domains can be received for a single entity. For example, example.com/general_home_store and example.com/homeimprovementstore can both be suitable domains to analyze the entity “example tool brand” regarding power tools. The domain and entity can be received from a request, such as request 228 as described above with respect to FIG. 2 or can be periodically received based on a preset schedule. For example, a client may want a entity analysis to occur monthly.

At 304, web pages associated with the domain are queried. In some implementations, the web pages are downloaded, as well as links on the web pages associated with the entity to be analyzed. The pages can be downloaded in an HTML format or parsed to extract text and particular formatting information from the HTML. In some implementations, the web page(s) are downloaded as images. In general, each page associated with the entity to be analy zed is queried/downloaded in order to provide a dataset with which to analyze entity information.

At 306, content associated with the entity to be analyzed is extracted from the queried domain. In some implementations, the content is supplemented with 3rd party or 1 st party external data (308). For example, an artificial intelligence system may maintain a separate database of related information, such as search queries or user reviews associated with a particular entity. In general, content is extracted from the domain and/or external data in order to generate an entity summary object or graph output that represents a holistic understanding of the entity. Examples of an entity summary object or graph output are provided below with respect to FIGS. 4 and 5.

At 310, one or more output objects are generated based on a further analysis of the extracted content. The generated output can be, for example, one or more digital content request recommendations (316), which can suggest a request price, time, type, and geographic location in order to enhance the effectiveness of the digital content request. In some implementations, the request recommendation 316 is generated based on the extracted entity content and additional information such as real time foot traffic 312 and/or real-time availability data 314. For example, a company who's entity sells ice cream may experience high demand during a period of unusually hot weather. Foot traffic data 312 may indicate that demand exceeds what the entity is capable of producing, and as such, digital content requests should be reduced. In another example, real-time inventory data 314 may indicate that an entity has a surplus of a top-selling product as identified by the content extracted at 306. Thus, the artificial intelligence system may recommend increasing request frequency in order to improve throughput of the product.

Another example output object could be an analysis of a particular selection of digital content in light of the entity summary extracted from the domain. The artificial intelligence system could generate a digital content score 320 given particular digital content to be analyzed 318 and the extracted content. The digital content score 320 can measure how well the digital content matches the entity on multiple dimensions and provide recommendations for improvements to the advertisement. Further the digital content score can be specific to a target audience, indicating an estimated effectiveness for a particular entity presenting a particular advertisement to a particular audience. In some implementations, this digital content score can be comparative to other similar entities or other entities within a particular category as the entity being analyzed. In some implementations the digital content score identifies sparsity in information, and provides recommended information based on similar information provided by other (e.g., competitive or cooperative) entities.

Additionally, the generated output object can be a graph output as described below in further detail with reference to FIG. 4 and FIG. 5.

FIG. 4 is an example graph output 400 of an entity analysis for a service-based company. FIG. 4 includes parent nodes 402, which each have one or more daughter nodes and are represented by rectangles, and leaf nodes 404, which do not have daughter nodes and are represented as ovals. Parent nodes 402 may further have additional parent nodes.

Graph output 400 is the result of analyzing the domain of a law firm “Law Firm, P.C.” The artificial intelligence system has broken the firm's services into two main branches, “corporate law” and “civil law,” each with its own subservices, competitors etc. Additionally, a brand has been identified with several leaf nodes. Each edge in graph output 400 can have an associated weight (e.g., a fraction between 0 and 1). Additionally each node can be weighted and include additional details or data.

One example final analysis or output (e.g., output object 310 as illustrated in FIG. 3), could be identified as a brand/service mismatch. For example, the artificial intelligence system may identify that a large portion of Law Firm, P.C.'s business is civil contract services, however their brand, reputation, and advertising focuses on corporate mergers and acquisitions. These insights could be used to generate a more representative brand in future advertising and presentation for Law Firm, P.C.

FIG. 5 is an example graph output 500 of a entity analysis for a products-based company. Similarly to FIG. 4, graph output 500 includes parent nodes 502 and leaf nodes 504 represented by rectangles and ovals respectively.

Graph output 500 is an analysis of the web pages of Apparel Store, which has identified two primary products that Apparel Store sells, footwear and accessories. Because the analysis disclosed herein involves using an artificial intelligence to comb a domain, it can both identify services and products, and develop insights related to both.

In some implementations, these graph outputs (e.g., graph output 500 and graph output 400) can be presented to a user, or the party requesting the entity analysis, and modified. For example, the Apparel Store 502 can review their associated graph 500 and review the identified competitors for “accessories,” prioritizing them based on the ones that the apparel store has identified as most important. In another example, the apparel store may identify that instead of or in addition to categorizing their footwear as “women's”, “men's”, and “Kid's”, they prefer to categorize them by season (e.g., “Winter”, “Fall”, “Summer”, etc.). In some implementations, these modified or augmented graph outputs can be returned to the artificial intelligence system (e.g., AI system 160 of FIG. 2) in order to provide feedback and training for future inference operations.

Further, the augmented graphs (e.g., user modified graphs), can be used for follow-on analysis, such as request recommendations 316 and generation of a digital content score 320 as described above with respect to FIG. 3.

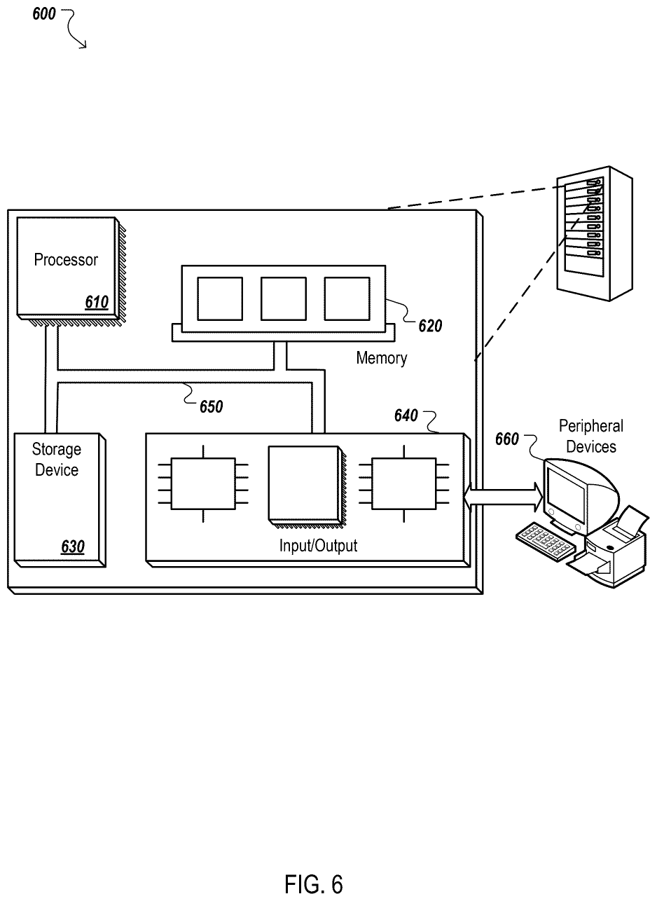

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e. g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving information identifying a domain to be analyzed;
identifying an entity referenced by the domain;
querying the domain and receiving a plurality of web pages located within the domain;
inputting the plurality of web pages to an artificial intelligence system that includes a large language model;
extracting, by the artificial intelligence system, first content from a first web page among the plurality of web pages, wherein the first content extracted from the first web page is in a first format;
extracting, by the artificial intelligence system, second content from a second web page among the plurality of web pages, wherein the second content extracted from the second web page is in a second format that differs from the first format;
generating, by the artificial intelligence system, third content representing a characterization of the entity based on the extracted first content and extracted second content, wherein the generated characterization is an interpretation of the extracted first content and extracted second content rather than a verbatim duplication of the extracted content; and
outputting the generated characterization to a display device or a data processing apparatus.

2. The method of claim 1, wherein extracting, by the artificial intelligence system, second content from a second web page among the plurality of web pages comprises extracting content that has not been structured for parsing by the artificial intelligence system.

3. The method of claim 1, wherein extracting, by the artificial intelligence system, first content from a first web page among the plurality of web pages comprises extracting content from the first web page irrespective of whether the first web page is structured for parsing by a content extractor.

4. The method of claim 1, further comprising:
presenting, to the entity, the characterization;
receiving, from the entity, modifications to the characterization; and
storing an augmented characterization based on the modifications to the characterization.

5. The method of claim 1, wherein generating the characterization comprises generating the characterization in a hierarchical graph structure comprising at least one parent node representing a first attribute of the characterization and at least one leaf node representing a second attribute of the characterization.

6. The method of claim 1, further comprising:
generating a digital component for the entity based on the characterization; and
distributing the digital component to third party client devices in conjunction with presentation of multiple different web pages provided by one or more different content providers, wherein each of the multiple different web pages is configured to have the digital component inserted at the third party client devices rendering the multiple different web pages.

7. The method of claim 6, further comprising:
generating, based on the characterization, one or more distribution constraints that restricts distribution to the third party client devices having characteristics that meet the one or more distribution constraints, wherein:
distributing the digital component to third party client devices in conjunction with presentation of multiple different web pages comprises:
distributing the digital component to a first set of the third party client devices having the characteristics that meet the one or more distribution constraints; and
preventing distribution of the digital component to a second set of the third party client devices lacking one or more of the characteristics that meet the one or more distribution constraints.

8. A non-transitory computer-readable storage medium having instructions stored thereon which, when executed by the one or more processors, cause the one or more processors to perform operations comprising:
receiving information identifying a domain to be analyzed;
identifying an entity referenced by the domain;
querying the domain and receiving a plurality of web pages located within the domain;
inputting the plurality of web pages to an artificial intelligence system that includes a large language model;
extracting, by the artificial intelligence system, first content from a first web page among the plurality of web pages, wherein the first content extracted from the first web page is in a first format;
extracting, by the artificial intelligence system, second content from a second web page among the plurality of web pages, wherein the second content extracted from the second web page is in a second format that differs from the first format;
generating, by the artificial intelligence system, third content representing a characterization of the entity based on the extracted first content and extracted second content, wherein the generated characterization is an interpretation of the extracted first content and extracted second content rather than a verbatim duplication of the extracted content; and
outputting the generated characterization to a display device or a data processing apparatus.

9. The computer-readable medium of claim 1, wherein extracting, by the artificial intelligence system, second content from a second web page among the plurality of web pages comprises extracting content that has not been structured for parsing by the artificial intelligence system.

10. The computer-readable medium of claim 1, wherein extracting, by the artificial intelligence system, first content from a first web page among the plurality of web pages comprises extracting content from the first web page irrespective of whether the first web page is structured for parsing by a content extractor.

11. The computer-readable medium of claim 1, further comprising:
presenting, to the entity, the characterization;
receiving, from the entity, modifications to the characterization; and
storing an augmented characterization based on the modifications to the characterization.

12. The computer-readable medium of claim 1, wherein generating the characterization comprises generating the characterization in a hierarchical graph structure comprising at least one parent node representing a first attribute of the characterization and at least one leaf node representing a second attribute of the characterization.

13. The computer-readable medium of claim 1, further comprising:
generating a digital component for the entity based on the characterization; and
distributing the digital component to third party client devices in conjunction with presentation of multiple different web pages provided by one or more different content providers, wherein each of the multiple different web pages is configured to have the digital component inserted at the third party client devices rendering the multiple different web pages.

14. The computer-readable medium of claim 13, further comprising:
generating, based on the characterization, one or more distribution constraints that restricts distribution to the third party client devices having characteristics that meet the one or more distribution constraints, wherein:
distributing the digital component to third party client devices in conjunction with presentation of multiple different web pages comprises:
distributing the digital component to a first set of the third party client devices having the characteristics that meet the one or more distribution constraints; and
preventing distribution of the digital component to a second set of the third party client devices lacking one or more of the characteristics that meet the one or more distribution constraints.

15. A system comprising:
one or more computers; and
a computer-readable storage device coupled to the one or more computers and having instructions stored thereon which, when executed by the one or more computer, cause the one or more computers to perform operations comprising:
receiving information identifying a domain to be analyzed;
identifying an entity referenced by the domain;
querying the domain and receiving a plurality of web pages located within the domain;
inputting the plurality of web pages to an artificial intelligence system that includes a large language model;
extracting, by the artificial intelligence system, first content from a first web page among the plurality of web pages, wherein the first content extracted from the first web page is in a first format;
extracting, by the artificial intelligence system, second content from a second web page among the plurality of web pages, wherein the second content extracted from the second web page is in a second format that differs from the first format;
generating, by the artificial intelligence system, third content representing a characterization of the entity based on the extracted first content and extracted second content, wherein the generated characterization is an interpretation of the extracted first content and extracted second content rather than a verbatim duplication of the extracted content; and
outputting the generated characterization to a display device or a data processing apparatus.

16. The system of claim 15, wherein extracting, by the artificial intelligence system, second content from a second web page among the plurality of web pages comprises extracting content that has not been structured for parsing by the artificial intelligence system.

17. The system of claim 15, wherein extracting, by the artificial intelligence system, first content from a first web page among the plurality of web pages comprises extracting content from the first web page irrespective of whether the first web page is structured for parsing by a content extractor.

18. The system of claim 15, wherein the instructions cause the one or more computers to perform operations further comprising:
presenting, to the entity, the characterization;
receiving, from the entity, modifications to the characterization; and
storing an augmented characterization based on the modifications to the characterization.

19. The system of claim 15, wherein generating the characterization comprises generating the characterization in a hierarchical graph structure comprising at least one parent node representing a first attribute of the characterization and at least one leaf node representing a second attribute of the characterization.

20. The system of claim 15, wherein the instructions cause the one or more computers to perform operations further comprising:
generating a digital component for the entity based on the characterization; and
distributing the digital component to third party client devices in conjunction with presentation of multiple different web pages provided by one or more different content providers, wherein each of the multiple different web pages is configured to have the digital component inserted at the third party client devices rendering the multiple different web pages.
